(19) United States
(12) Patent Application Publication
(10) Pub. No.: US 2025/0237932 A1
(43) Pub. Date: Jul. 24, 2025

(54) CAMERA-BASED WEARABLE HEADGEAR

(71) Applicant: RealWear, Inc., Vancouver, WA (US)

(72) Inventors: Chris Iain PARKINSON, Richland, WA (US); Noah Nicholas BALMER, Vancouver, WA (US); George Henry HINES, Petaluma, CA (US)

(21) Appl. No.: 18/417,675

(22) Filed: Jan. 19, 2024

(51) Int. Cl. G02B 27/01; G02C 3/00; G02C 3/02; G02C 11/00

(52) U.S. Cl. CPC G02B 27/0176; G02C 3/003; G02C 3/02; G02C 11/10; G03B 17/561; G02B 2027/0138

(57) ABSTRACT

A camera-based wearable headgear having a camera cradle and having a first camera cradle end opposite a second camera cradle end. The wearable headgear can also have a fixed length strap extending from the camera cradle at the first camera cradle end and a variable length strap extending from the camera cradle at the second camera cradle end. Aspects include the wearable headgear having a battery housing having a first battery housing end opposite a second battery housing end and the fixed length strap extending from the camera cradle at the first camera cradle end to the first battery housing end. Aspects also include the fixed length strap having a first mount extending within the camera cradle and securing the camera cradle with the fixed length strap, and the fixed length strap having a body that extends from the camera cradle at the first camera cradle end.

### BACKGROUND

Wearable headgear can be equipped with a camera. This allows for a variety of applications including recording a video or allowing for a remote viewer to see what a wearer of the headgear is seeing and to communicate with the wearer. In sports and outdoor activities, athletes and adventurers use them to capture dynamic, immersive footage of their experiences, from skydiving to mountain biking. In professional settings, these devices serve practical purposes; for instance, in construction, they can be used for documenting site progress or in emergency services for real-time situational assessment. Furthermore, in creative fields like filmmaking and content creation, these headgears offer a unique vantage point, allowing for the capture of hands-free, point-of-view footage. Additionally, in the realm of security and law enforcement, they offer a means of recording operations and interactions, adding a layer of accountability and documentation. This blend of practicality and innovation makes camera-equipped wearable headgear a versatile tool in both professional and recreational arenas. Many of these headgear are configured to restrain all necessary components for operation of the camera in one location on the user's head.

### SUMMARY

At a high level, the technology described herein includes systems for a camera-based wearable headgear.

For instance, a camera-based wearable headgear can have a camera cradle. The camera cradle can have a first end opposite a second end as well as a camera to record or broadcast a video. In some aspects, the camera cradle can be located on a front of a user's head so that the camera can have the same view as the wearer. To secure the camera cradle to the user's head, the headgear can have a fixed length strap extending from the first end of the camera cradle and a variable length strap extending from the second end of the camera cradle.

In some aspects, a battery housing can be included having a first end opposite a second end. The fixed length strap can have a first mount extending within the camera cradle to secure the camera cradle with the fixed length strap, and a second mount extending within the battery housing to secure the battery housing with the fixed length strap. Additionally, in some aspects, a pad is included that has a first pad end proximate the second end of the camera cradle and at least partially extends under a body of the camera cradle.

This summary is intended to introduce a selection of concepts in a simplified form that are further described below in the detailed description section of this disclosure. This summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the following or learned by practice of the technology.

### BRIEF DESCRIPTION OF THE DRAWINGS

The present technology is described in detail below with reference to the attached drawing figures, wherein:

FIG. 1 illustrates an example camera-based wearable headgear, in accordance with an aspect described herein;

FIG. 2 is an exploded view of the headgear of FIG. 1, in accordance with an aspect described herein;

FIG. 3 is a magnified view of a camera cradle of the headgear of FIG. 1, in accordance with an aspect described herein;

FIG. 4 is a magnified view of a battery housing of the headgear of FIG. 1, in accordance with an aspect described herein;

FIG. 5 is a perspective view of a fixed length strap of the headgear of FIG. 1, in accordance with an aspect described herein;

FIG. 6A is an isolated view of the fixed length strap of FIG. 1, in accordance with an aspect described herein;

FIG. 6B is another isolated view of the fixed length strap of FIG. 1, in accordance with an aspect described herein;

FIG. 7 is a perspective view of a variable length strap of the headgear of FIG. 1, in accordance with an aspect described herein;

FIG. 8A illustrates the headgear of FIG. 1 when the variable length strap is in a fully retracted state, in accordance with an aspect described herein;

FIG. 8B illustrates the headgear of FIG. 1 when the variable length strap is in a fully extended state, in accordance with an aspect described herein;

### DETAILED DESCRIPTION

Conventional camera-based headgear often encounters several problems, particularly when integrating the camera and battery in a single, non-modular unit. Conventional headgear are often not versatile enough to be comfortably used in a variety of settings, from professional tasks to recreational activities. These issues need to be addressed for a more functional and comfortable user experience.

For example, in traditional designs, where the camera and battery are housed together, there tends to be an uneven weight distribution. Conventional headgear often lacks sufficient adjustability to accommodate different head sizes and shapes comfortably. The absence of a variable-length strap for fit adjustment exacerbates this issue. Integrating the battery with the camera often limits the size and capacity of the battery, reducing operational time and potentially leading to longer charging periods. Conventional headgear can also make it challenging to replace or upgrade individual components like the battery or camera, often necessitating the replacement of the entire unit. The front-heavy design of traditional headgear can also cause the camera to slip or move positions when in use, as it fails to counterbalance the weight effectively. The need to incorporate a battery within the camera module often results in bulkier and heavier camera units, which can be obtrusive and less comfortable for the user. Furthermore, the lack of integrated cable management in traditional designs can lead to issues with entanglement, inconvenience, and a less streamlined appearance. Overall, these design limitations can lead to a compromised user experience, with reduced comfort, convenience, and functionality.

In order to address these issues, the technology described herein includes a camera-based wearable headgear that includes modular components, balanced weight distribution, and improved adjustability without sacrificing cable management considerations to enhance user comfort, safety, and the overall functionality of the headgear. For example, separating the battery component from the camera in wearable headgear, where the camera is mounted at the front and the battery is placed at the back of the user's head, offers several advantages, particularly when considering functionality aspects. By positioning the battery at the back and the camera at the front, the headgear achieves a more balanced weight distribution. This minimizes the load on any single point on the head, enhancing comfort for the wearer, especially during prolonged use. Furthermore, the use of a fixed-length strap with integrated power cables ensures a stable and secure fit, as it prevents excessive movement of the headgear. At the same time, the variable-length strap allows for adjustability, accommodating different head sizes and shapes, and enabling users to find the most comfortable fit. Additionally, integrating power cables into one of the straps not only serves a functional purpose but also helps in managing and concealing cables, reducing the risk of entanglement. This separation also minimizes the risk of overheating in the camera itself, as heat sources are distributed. Placing the heavier battery at the back can also help counterbalance the weight of the camera at the front, which can help ergonomic balance of the headgear. Having a separate battery unit also allows for the inclusion of a larger or more efficient battery without adding bulk to the camera module. This can lead to longer operational times and potentially faster charging capabilities. Furthermore, separating the battery from the camera module makes it easier to replace or upgrade individual components. If the battery degrades or a more advanced camera is needed, only the specific part can be swapped out without the need to replace the entire headgear. With the battery housed separately, the camera unit can also be made more compact and lightweight. This can lead to a less obtrusive design and may offer more flexibility in terms of camera module design and placement. In summary, the camera-based headgear presently disclosed offers significant ergonomic, functional, and safety benefits, making the device more user-friendly and adaptable to various needs and environments when compared to conventional camera-based headgear.

One example of a suitable camera-based headgear can have a camera cradle. The camera cradle can have a first camera cradle end opposite a second camera cradle end as well as a camera to record and/or broadcast a video. The camera cradle can be located on a front of a user's head so that the camera can have the same view as the wearer. To secure the camera cradle to the user's head, the headgear can have a fixed length strap extending from the first camera cradle end and a variable length strap extending from the second camera cradle end. In some aspects, a battery housing can be included having a first battery housing end opposite a second battery housing end. The fixed length strap can have a first mount extending within the camera cradle and securing the camera cradle with the fixed length strap, and a second mount extending within the battery housing and securing the battery housing with the fixed length strap. When the variable length strap is in a fully retracted state, the variable length strap is shorter than the fixed length strap, and when it is in a fully extended state, the variable length strap is longer than the fixed length strap.

Additionally, a pad can be included that has a first pad end proximate the second camera cradle end and at least partially extends under a body of the camera cradle. The headgear can include a fixed length power cable extending from a battery housing and through the fixed length strap, wherein the fixed length power cable electrically couples a battery at the battery housing with the camera. The headgear can also include a vertical arm coupled to the camera cradle at the first camera cradle end, and the camera is coupled to the vertical arm.

The aforementioned embodiments have been provided as examples of the technology that may be practiced from the present disclosure. They are intended to be examples and are provided to aid in understanding the technology and its benefits. Additional features and embodiments are further described with reference to the figures.

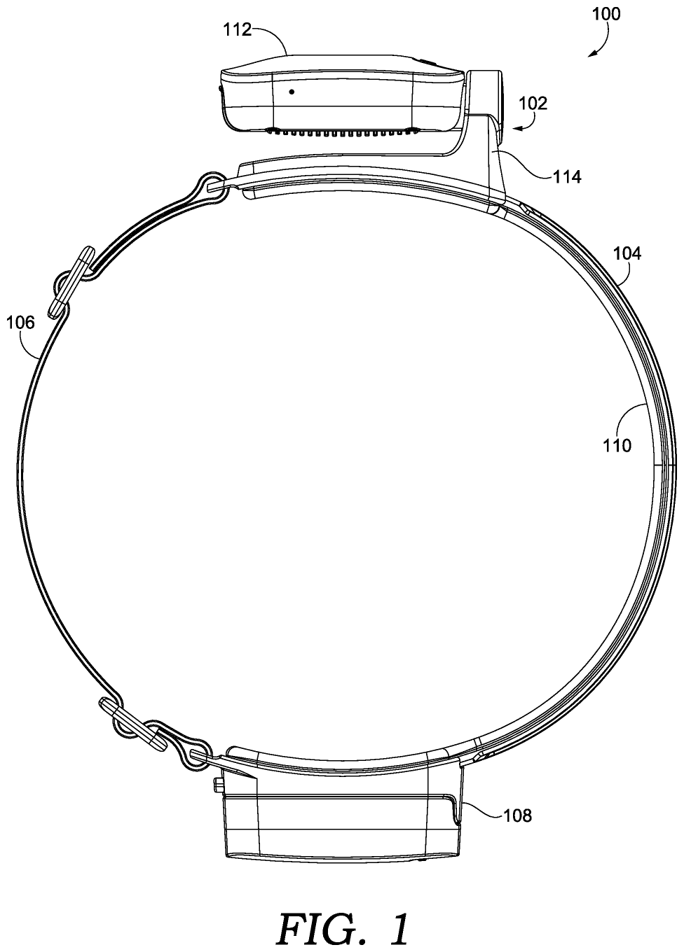

Referring initially to FIG. 1, a camera-based wearable headgear 100 is depicted in its fully assembled state. The headgear 100 of the present invention can provide a variety of benefits. These benefits include things such as balanced weight distribution, adjustability and comfort, efficient cable management, and others discussed above.

The headgear 100 includes a camera cradle 102 and a battery housing 108 secured by one or more of a fixed length strap 104 and a variable length strap 106. The camera cradle 102 can be generally positioned at a front of a user's head while the battery housing 108 can be generally positioned at a back of the user's head to counterbalance the camera cradle 102 in a wearable configuration. Placing the battery housing 108 generally at the back of the user's head can still provide adequate counterbalancing when a length of the variable length strap 106 is adjusted. Although the camera cradle 102 and the battery housing 108 are pictured as symmetrical in FIG. 1, a configuration (e.g., lengths in an initial state) of the fixed length strap 104 and the variable length strap 106 can be such that the battery housing 108 is between a back of the user's ear and a center-back of the user's head. Such a configuration can be beneficial so that the length of the fixed length strap 104 can be reduced and allow for more adjustments of the variable length strap 106. Additionally, for the user with an average head size, they can lay on their backs, with their head on the ground, without laying directly on the battery housing 108.

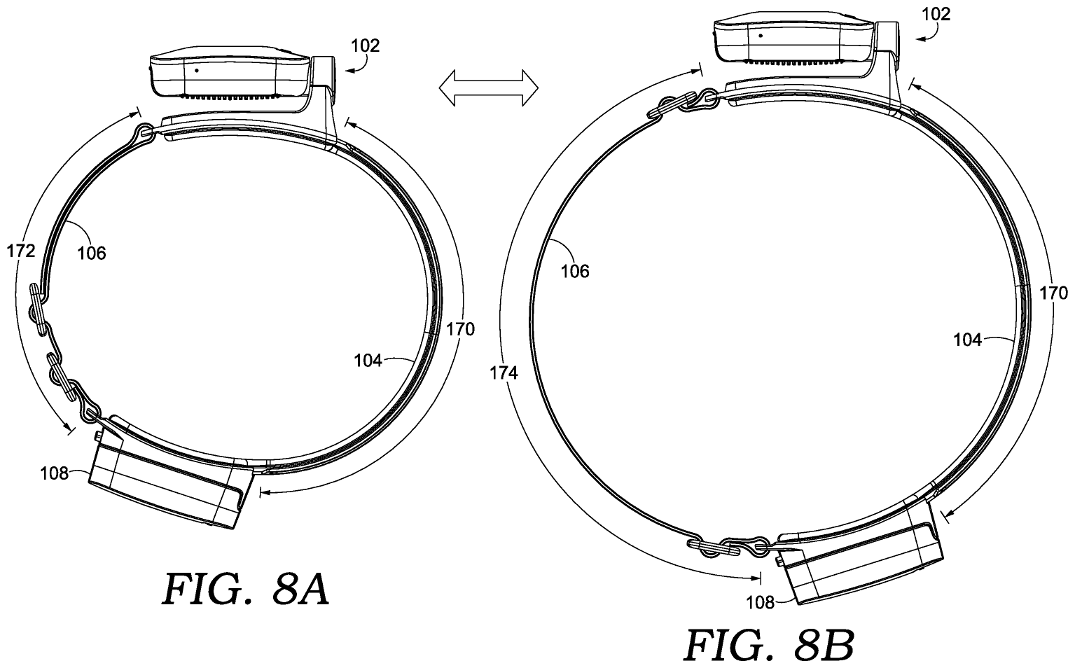

For example, as seen in FIGS. 8A and 8B, when the variable length strap 106 is in a fully retracted state, a length 172 of the variable length strap can be shorter than a length 170 of the fixed length strap 104 while still retaining the battery housing 108 generally at the back of the user's head. Similarly, when the variable length strap 106 is in a fully extended state, a length 174 of the variable length strap 106 can be longer than the length 170 of the fixed length 104 while also still retaining the battery housing 108 generally at the back of the user's head. Separating the camera cradle 102 and the battery housing in such a way can allow for the inclusion of a larger or more efficient battery without adding bulk to the camera cradle 102 as compared to traditional headgear. Moreover, since most use cases will involve the variable length strap 106 being positioned between the fully extended state and the fully retracted state, this design allows the battery housing 108 to generally be positioned at a location where efficient balance is achieved for almost all fit sizes. Put another way, this allows a continuous for continuous length adjustment for the headset, while maintaining a balance through all configurations.

The fixed length strap 104 can be comprised of a rigid or semi-rigid material (e.g., neoprene, silicon, latex, thermoplastics, and the like) with some flexibility so that the positioning of the camera cradle 102 relative to the battery housing 108 can generally be maintained while still allowing the headgear 100 to be adaptable for a particular user's head. For example, materials with a Shore A hardness of about 50-90 can be used. In some cases, a Shore A hardness of 50-90 can be used.

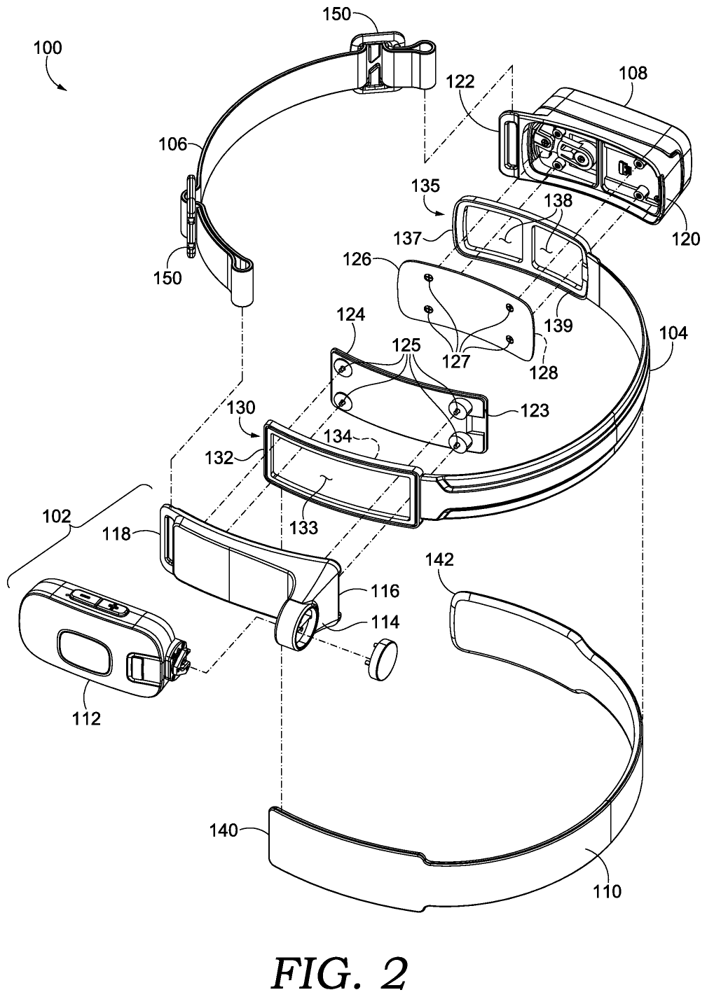

The variable length strap 106 can be comprised of a pliable, elastic, or otherwise adjustable material for added comfort and adjustability. One or more variable length strap adjusters 150 (FIGS. 2, 4, and 7) can be included with the variable length strap 106 to adjust the length of the variable length strap 106. While depicted as a two-bar slide adjuster in the figures, the one or more variable length strap adjusters 150 may take the form of any suitable strap length adjuster for shortening or increasing the length of a strap component to the headgear 100.

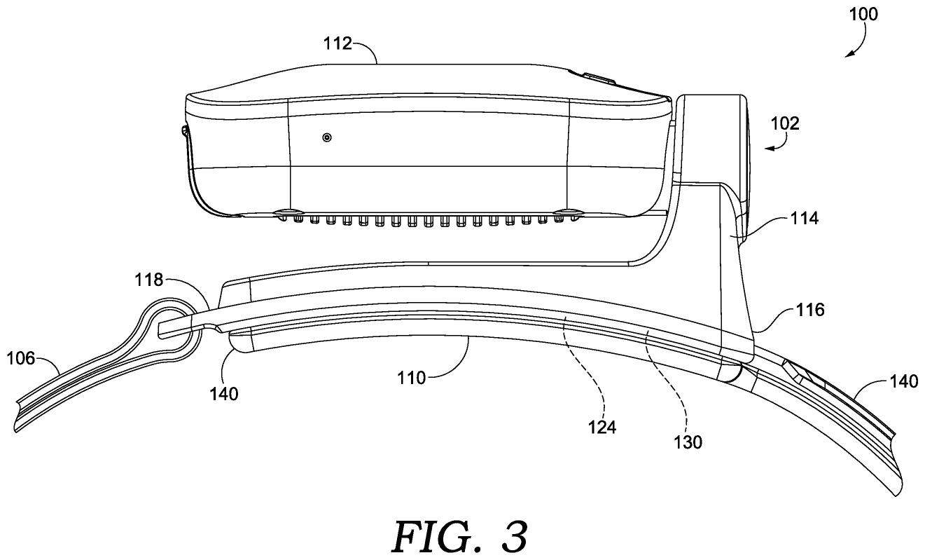

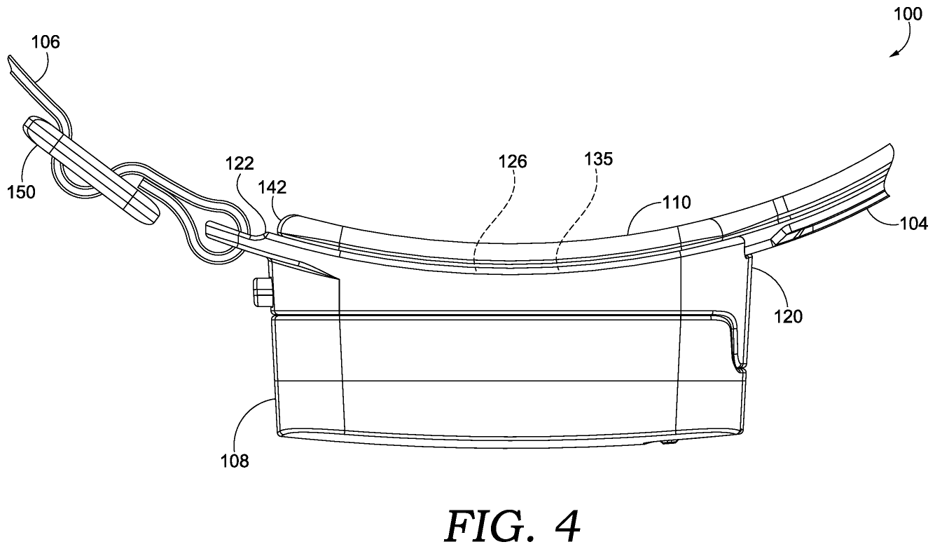

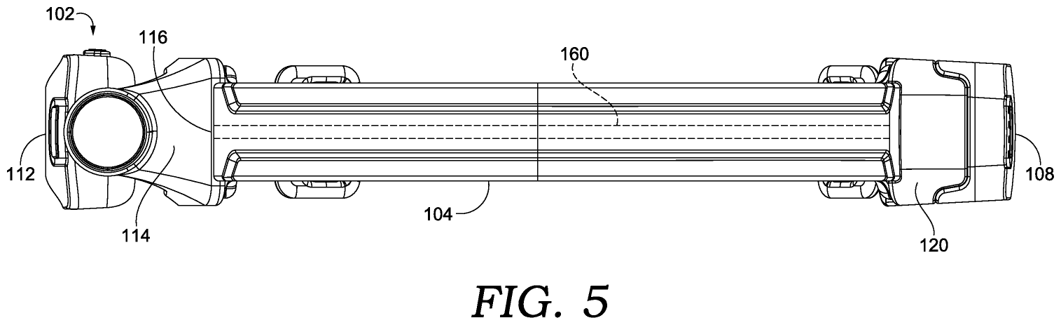

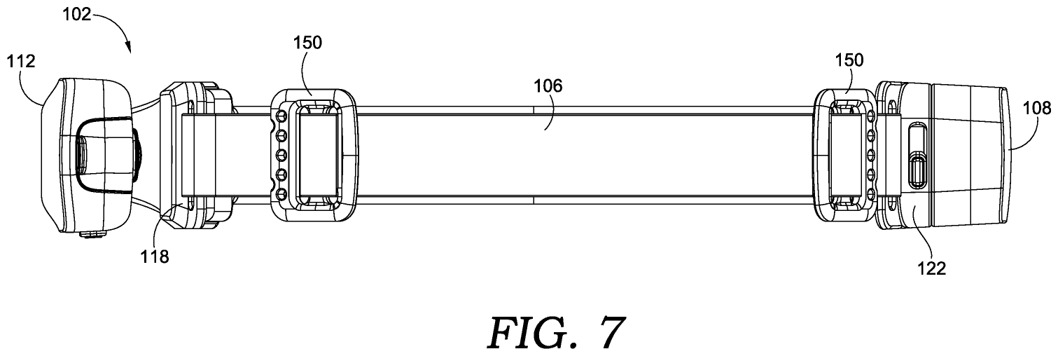

The camera cradle 102 of the headgear 100 can have a first camera cradle end 116 opposite a second camera cradle end 118 (FIGS. 2 and 3). A body of the camera cradle 102 can extend between the first camera cradle end 116 and the second camera cradle end 118. Additionally, the battery housing 108 can have a first battery housing end 120 opposite a second battery housing end 122 (FIGS. 2 and 4). A body of the battery housing 108 can extend between the first battery housing end 120 and the second battery housing end 122. A body of the fixed length strap 104 can extend from the first camera cradle end 116 to the first battery housing end 120 (FIGS. 2 and 5) and the variable length strap 106 can extend from the second camera cradle end 118 to the second battery housing end 122 (FIGS. 2 and 7). For example, the fixed length strap 104 is illustrated as extending from the camera cradle 102 at the first camera cradle end 116, and the fixed length strap 104 is illustrated as extending from the first battery housing end 120. Similarly, the variable length strap 106 is illustrated as extending from the camera cradle 102 at the second camera cradle end 118, and the variable length strap 106 is illustrated as extending from the battery housing 108 at the second battery housing end 122. The second camera cradle end 118 and the second battery housing end 122 can include an extension with an aperture that ends of the variable length strap 106 can loop through to couple to the camera cradle 102 and the battery housing 108 (FIGS. 1-4 and 7).

As seen in FIGS. 1-4, the headgear 100 can include a pad 110. The pad 110 can comprise suitable materials for providing a cushion between components of the headgear 100 and the user's head. For example, the pad 110 could comprise foam, fiber, rubber, etc. As seen in FIGS. 2 and 3, the pad 110 can have a first pad end 140 proximate the second camera cradle end 118. As seen in FIGS. 2 and 4, the pad 110 can have a second pad end 142 proximate the second battery housing end 122. The pad 110 extends at least partially under the fixed length strap 104 between the first pad end 140 and the second pad end 142 in order to provide cushioning between the user's head and the camera cradle 102, the fixed length strap 104, and the battery housing 108. This example configuration advantageously maximizes the pad area along the fixed length features of the headgear 100, which include the camera cradle 102, the battery housing 108, and the fixed length strap 104 in the example aspects that are illustrated.

In another example, the pad 110 can comprise a first portion having a first pad end proximate the second camera cradle 118 end and a second pad end proximate the first camera cradle end 116. The first portion of the pad 110 in this example can at least partially extend under the body of the camera cradle 102. Continuing with the example, the pad 110 can also comprise a second portion having a first pad end proximate the first battery housing end 120 and a second pad end proximate the second battery housing end 122. The second portion of the pad 110 in this example can at least partially extend under a body of the battery housing 108. In some aspects, the pad 110 can comprise a third portion that extends under the body of the fixed length strap 104; however, in other aspects, the pad 110 may not extend under the fixed length strap 104.

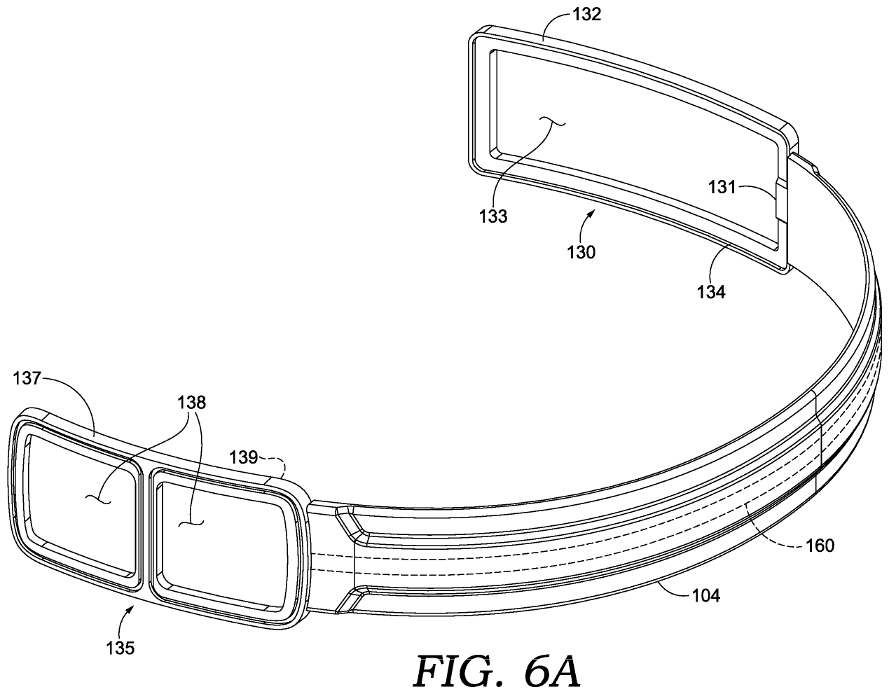

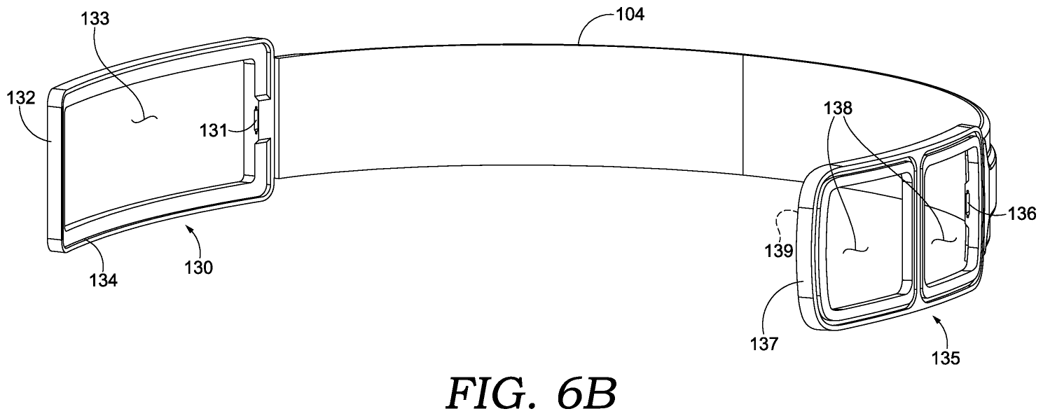

As depicted in FIGS. 5 and 6A, a power cable 160 can be extend through the fixed length strap 104 to connect a battery in the battery housing 108 to the camera 112. Extending the power cable 160 through the fixed length strap 104 helps in managing and concealing the power cable 160, reducing the risk of entanglement while also shielding the power cable 160 from the outside environment (e.g., abrasion, moisture, or impact). In some aspects, the one or more power cables can be overmolded into the fixed length strap 104. Additionally, extending the power cable 160 into the fixed length strap 104 allows a fixed length of power cables to be used, which helps to prevent breakage or disconnection of the power cable when the variable length strap is adjusted 106 and during general use.

In order to provide the camera 112 with an ability to rotate it's field of view (e.g., vertically), a vertical arm 114 can be included in the headgear 100, as seen in FIGS. 1-3 and 5. The vertical arm 114 can extend from a location proximate the first camera cradle end 116, which provides additional stability for the camera 112 that is coupled to the vertical arm 114 due to the fixed length strap 104. The rigid or semi-rigid fixed length strap 104 helps reduce any shaking or unwanted movements of the camera 112 during operation when the vertical arm 112 extends proximate the first camera cradle end 116 by providing a more stable foundation. In some aspects, the camera 112 is removably coupled to the vertical arm 114 and the vertical arm 114 is also removably coupled to the camera cradle 102. This makes it easier to replace or upgrade the camera 112 or the vertical arm 114.

As depicted in FIGS. 2, 6A, and 6B, the fixed length strap 104 can include a first mount 130 and a second mount 135 extending from the body of the fixed length strap 104 that assist in coupling the fixed length strap 104 to the camera 102 and the battery housing 108, respectively. The first mount 130 can extend at least partially within the camera cradle 102 and be coupled to the camera cradle 102 with a camera cradle cover 124. A lip 123 of the camera cradle cover 124 can align with an inner lip 134 of a plurality of sidewalls 132 of the first mount 130. One or more attachment points 125 of the camera cradle cover 124 can extend through an aperture 133 of the first mount 130 that is at least partially defined by the plurality of sidewalls 132. Advantageously, coupling the fixed length strap 104 within the camera cradle 102 allows a power cable channel opening 131 for the power cable 160 to also be located within the camera cradle 102, shielding the electrical equipment from the outside environment while maintaining a secure and stable connection.

The second mount 135 can extend at least partially within the battery housing 108 and be coupled to the battery housing 108 with a battery housing cover 126. A lip 128 of the battery housing cover 126 can align with an inner lip 139 of plurality of sidewalls 137 of the second mount 135. One or more attachment points 127 of the battery housing cover 126 can extend through one or more apertures 138 of the second mount 135 that are at least partially defined by the plurality of sidewalls 137. Coupling the fixed length strap 104 within the battery housing 108 also allows for a power cable channel opening 136 for the power cable 160 to be located and extend from the fixed length strap 104 to within the battery housing 108, shielding the electrical equipment from the outside environment while maintaining a secure and stable connection.

FIG. 3 illustrates a magnified view of an external configuration of the headgear 100 when the first mount 130 of the fixed length strap 104 is secured to the camera cradle 102 with the camera cradle cover 124. For example, the pad 110 and the camera cradle 102 can enclose the camera cover 124 and the first mount 130 from the outside environment. When the first mount 130 is enclosed within the camera cradle 102, it is better protected from external elements like dust, moisture, and impact. This can significantly increase the lifespan of both the first mount 130 and the camera cradle 102. The first mount 130 being internal the camera cradle 102 also provides a more stable and secure connection to the camera 112. This reduces the risk of the camera shaking or dislodging, which is beneficial for capturing clear, steady images and videos. As discussed previously, incorporating the power cable 160 within the fixed length strap 104 from the battery housing 108 to the camera cradle 102 allowed the power cable 160 to exit directly inside the camera cradle 102 to provide power to the camera 112 or any hardware components at the camera cradle 102. By having the power cable 160 exit directly inside the camera cradle 102, the connection is likely to be more stable and secure, reducing the risk of power loss or connectivity issues due to loose connections or cable movement. Furthermore, with fewer external components, the headgear 100 is easier to set up, use, and maintain, which can save time and effort, especially in situations where quick setup and breakdown are necessary. With the first mount 130 secured inside the camera cradle 102, there's less need to adjust or fix external components, making the headgear 100 more user-friendly for users who are not technically inclined.

FIG. 4 illustrates a magnified view of an external configuration of the headgear 100 when the second mount 135 of the fixed length strap 104 is secured to the battery housing 108 with the battery housing cover 126. For example, the pad 110 and the battery housing 108 can enclose the battery cover 126 and the second mount 135 from the outside environment. In addition to having similar benefits as described previously with regard to the camera cradle 102 in FIG. 3, placing the second mount 135 within the battery housing 108 can help balance the weight of the headgear 100, especially when the battery is a relatively significant weight component. This can also lead to a more compact and efficient setup, as it minimizes the need for additional mounting hardware. By securing the fixed length strap 104 to the battery housing 108 through the second mount 135 (e.g., through the plurality of inner walls 137 extending around the boundary of the inside of the battery housing 108), a more secure and robust securing mechanism is provided, ensuring that the connection (e.g., fixed length strap 104) between the battery housing 108 and the camera cradle 102 remains firmly in place, even in demanding environments.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, elements described herein can be implemented as discrete or distributed components or in conjunction with other components, and in any suitable combination and location. Some elements can be omitted altogether.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

In addition, words such as “a” and “an,” unless otherwise indicated to the contrary, include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

Terms, such as “having,” “including,” or the like, and derivatives thereof, are intended to have the same broad meaning as “comprising,” unless otherwise expressly indicated.

Unless explicitly indicated otherwise, ranges are intended to provide example embodiments that are suitable for some aspects and implementations. They are not intended to exclude other embodiments of the technology having values falling outside of the given ranges.

From the foregoing, it will be seen that this technology is one well adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated the accompanying drawings is to be interpreted as illustrative and not in a limiting sense.

Some example aspects that can be practice from the foregoing description include the following:

Aspect 1: A camera-based wearable headgear comprising a camera cradle comprising a camera and having a first cradle end opposite a second cradle end; a fixed length strap of the headgear extending from the camera cradle at the first cradle end; and a variable length strap of the headgear extending from the camera cradle at the second cradle end.

Aspect 2: Aspect 1, further comprising a fixed length power cable extending from a battery housing and through the fixed length strap, wherein the fixed length power cable electrically couples a battery at the battery housing with the camera.

Aspect 3: Any of Aspects 1-2, further comprising a battery housing comprising a first housing end opposite a second housing end, wherein the fixed length strap extends from the camera cradle at the first cradle end to the first housing end, and wherein the variable length strap extends from the camera cradle at the second cradle end to the second housing end.

Aspect 4: Aspect 3, wherein the fixed length strap comprises a first mount extending within the camera cradle and securing the camera cradle with the fixed length strap, and wherein the fixed length strap comprises a second mount extending within the battery housing and securing the battery housing with the fixed length strap.

Aspect 5: Any of Aspects 4-5, wherein, in a fully retracted state, the variable length strap is shorter than the fixed length strap, and wherein, in a fully extended state, the variable length strap is longer than the fixed length strap.

Aspect 6: Any of Aspects 1-5, wherein a vertical arm is coupled to the camera cradle at the first cradle end, and wherein the camera is coupled to the vertical arm.

Aspect 7: Any of Aspects 1-6, further comprising a pad that comprises a first pad end proximate the second cradle end, wherein the pad at least partially extends under a body of the camera cradle.

Aspect 8: Aspect 7, wherein the pad further comprises a second pad end opposite the first pad end, the second pad end proximate the first camera cradle end.

Aspect 9: A camera-based wearable headgear comprising a camera having a first cradle end opposite a second cradle end; a battery housing comprising a first housing end opposite a second housing end; and a fixed length strap of the headgear extending from the camera cradle at the first cradle end to the first housing end.

Aspect 10: Aspect 9, further comprising a fixed length power cable extending from the battery housing and through the fixed length strap, wherein the fixed length power cable electrically couples a battery at the battery housing with the camera.

Aspect 11: Any of Aspects 9-10, wherein the fixed length strap comprises a first mount extending within the camera cradle and securing the camera cradle with the fixed length strap, and wherein the fixed length strap comprises a second mount extending within the battery housing and securing the battery housing with the fixed length strap.

Aspect 12: Any of Aspects 9-11, further comprising a pad that comprises a first pad end proximate the second camera cradle end and a second pad end proximate the first camera cradle end, wherein the pad at least partially extends under a body of the camera cradle.

Aspect 13: Any of Aspects 9-12, wherein a vertical arm is coupled to the camera cradle at the first cradle end, and wherein the camera is coupled to the vertical arm.

Aspect 14: Any of Aspects 9-13, further comprising a variable length strap of the headgear extending from the camera cradle at the second cradle end to the second housing end, wherein, in a fully retracted state, the variable length strap is shorter than the fixed length strap, and wherein, in a fully extended state, the variable length strap is longer than the fixed length strap.

Aspect 15: A camera-based wearable headgear comprising a camera cradle comprising a camera and having a first cradle end opposite a second cradle end; a fixed length strap comprising a first mount extending within the camera cradle and securing the camera cradle with the fixed length strap, wherein a body of the fixed length strap extends from the camera cradle at the first cradle end; and a pad comprising a first pad end proximate the second cradle end, wherein the pad at least partially extends under a body of the camera cradle.

Aspect 16: Aspect 15, further comprising a battery housing comprising a first housing end opposite a second housing end, wherein the fixed length strap extends from the camera cradle at the first cradle end to the first housing end, and wherein the variable length strap extends from the camera cradle at the second cradle end to the second housing end.

Aspect 17: Aspect 16, wherein the fixed length strap comprises a second mount extending within the battery housing and securing the battery housing with the fixed length strap.

Aspect 18: Any of Aspects 16-17, further comprising a variable length strap of the headgear extending from the camera cradle at the second cradle end to the second housing end, wherein, in a fully retracted state, the variable length strap is shorter than the fixed length strap, and wherein, in a fully extended state, the variable length strap is longer than the fixed length strap.

Aspect 19: Any of Aspects 16-18, wherein the pad further comprises a second pad end proximate the first camera cradle end.

Aspect 20: Any of Aspects 15-19, wherein a vertical arm is coupled to the camera cradle at the first cradle end, and wherein the camera is coupled to the vertical arm.

What is claimed is:

1. A camera-based wearable headgear comprising:
a camera cradle comprising a camera and having a first camera cradle end opposite a second camera cradle end;
a fixed length strap of the headgear extending from the camera cradle at the first camera cradle end; and
a variable length strap of the headgear extending from the camera cradle at the second camera cradle end.

2. The headgear of claim 1, further comprising a fixed length power cable extending from a battery housing and through the fixed length strap, wherein the fixed length power cable electrically couples a battery at the battery housing with the camera.

3. The headgear of claim 1, further comprising a battery housing comprising a first battery housing end opposite a second battery housing end, wherein the fixed length strap extends from the camera cradle at the first camera cradle end to the first battery housing end, and wherein the variable length strap extends from the camera cradle at the second camera cradle end to the second battery housing end.

4. The headgear of claim 3, wherein the fixed length strap comprises a first mount extending within the camera cradle and securing the camera cradle with the fixed length strap, and wherein the fixed length strap comprises a second mount extending within the battery housing and securing the battery housing with the fixed length strap.

5. The headgear of claim 3, wherein, in a fully retracted state, the variable length strap is shorter than the fixed length strap, and wherein, in a fully extended state, the variable length strap is longer than the fixed length strap.

6. The headgear of claim 1, wherein a vertical arm is coupled to the camera cradle at the first camera cradle end, and wherein the camera is coupled to the vertical arm.

7. The headgear of claim 1, further comprising a pad that comprises a first pad end proximate the second camera cradle end, wherein the pad at least partially extends under a body of the camera cradle.

8. The headgear of claim 7, wherein the pad further comprises a second pad end opposite the first pad end, the second pad end proximate the second housing end.

9. A camera-based wearable headgear comprising:
a camera cradle comprising a camera and having a first camera cradle end opposite a second camera cradle end;
a battery housing comprising a first battery housing end opposite a second battery housing end; and
a fixed length strap of the headgear extending from the camera cradle at the first camera cradle end to the first battery housing end.

10. The headgear of claim 9, further comprising a fixed length power cable extending from the battery housing and through the fixed length strap, wherein the fixed length power cable electrically couples a battery at the battery housing with the camera.

11. The headgear of claim 9, wherein the fixed length strap comprises a first mount extending within the camera cradle and securing the camera cradle with the fixed length strap, and wherein the fixed length strap comprises a second mount extending within the battery housing and securing the battery housing with the fixed length strap.

12. The headgear of claim 9, further comprising a pad that comprises a first pad end proximate the second camera cradle end and a second pad end proximate the second battery housing end, wherein the pad at least partially extends under a body of the camera cradle.

13. The headgear of claim 9, wherein a vertical arm is coupled to the camera cradle at the first camera cradle end, and wherein the camera is coupled to the vertical arm.

14. The headgear of claim 9, further comprising a variable length strap of the headgear extending from the camera cradle at the second camera cradle end to the second battery housing end, wherein, in a fully retracted state, the variable length strap is shorter than the fixed length strap, and wherein, in a fully extended state, the variable length strap is longer than the fixed length strap.

15. A camera-based wearable headgear comprising:
a camera cradle comprising a camera and having a first camera cradle end opposite a second camera cradle end;
a fixed length strap comprising a first mount extending within the camera cradle and securing the camera cradle with the fixed length strap, wherein a body of the fixed length strap extends from the camera cradle at the first camera cradle end; and
a pad comprising a first pad end proximate the second camera cradle end, wherein the pad at least partially extends under a body of the camera cradle.

16. The headgear of claim 15, further comprising a battery housing comprising a first battery housing end opposite a second battery housing end, wherein the fixed length strap extends from the camera cradle at the first camera cradle end to the first battery housing end, and wherein the variable length strap extends from the camera cradle at the second camera cradle end to the second battery housing end.

17. The headgear of claim 16, wherein the fixed length strap comprises a second mount extending within the battery housing and securing the battery housing with the fixed length strap.

18. The headgear of claim 16, further comprising a variable length strap of the headgear extending from the camera cradle at the second camera cradle end to the second battery housing end, wherein, in a fully retracted state, the variable length strap is shorter than the fixed length strap, and wherein, in a fully extended state, the variable length strap is longer than the fixed length strap.

19. The headgear of claim 16, wherein the pad further comprises a second pad end proximate the first camera cradle end.

20. The headgear of claim 15, wherein a vertical arm is coupled to the camera cradle at the first camera cradle end, and wherein the camera is coupled to the vertical arm.
